(19) United States
(12) Patent Application Publication
(10) Pub. No.: US 2012/0015075 A1
(43) Pub. Date: Jan. 19, 2012

(54) CHEWABLE SUPPLEMENT WITH LIVE MICROORGANISMS

(75) Inventor: Judy Davis, San Clemente, CA (US)

(73) Assignee: Hero Nutritionals, LLC, San Clemente, CA (US)

(21) Appl. No.: 13/165,572

(22) Filed: Jun. 21, 2011

Related U.S. Application Data
(60) Provisional application No. 61/363,703, filed on Jul. 13, 2010.

(51) Int. Cl. A23L 1/48

(52) U.S. Cl. 426/61

(57) ABSTRACT

A chewable composition for the oral delivery of live microorganisms is provided. The chewable composition includes a delivery vehicle and an active ingredient incorporated therein. The delivery vehicle may include an organic or non-organic gummy candy including a binding agent, sweetener, flavoring, and/or coloring. The active ingredient may include a predetermined amount of at least one probiotic. The delivery vehicle may also include a predetermined amount of at least one prebiotic. The delivery vehicle may also include any combination of nutraceuticals, vitamins, minerals, antioxidants, soluble and insoluble fiber, herbs, plants, probiotics, prebiotics, antioxidants, amino acids, fatty acids, digestive enzymes, dietary supplements, or any other health promoting ingredient.

### RELATED APPLICATIONS

This application claims priority from U.S. Provisional Application No. 61/363,703, filed on Jul. 13, 2010, titled CHEWABLE SUPPLEMENT WITH LIVE MICROORGANISMS, which application is incorporated in its entirety by reference herein.

### BACKGROUND OF THE INVENTION

1. Field of the Invention

The invention relates generally to a chewable dietary supplement, and more particularly to a chewable composition for the oral delivery of live microorganisms such as probiotics, where the chewable composition may include prebiotics, and methods for manufacturing the same.

2. Related Art

Each year, millions of men and women die from heart disease around the world. At least 90 million people in the United States alone report having some form of chronic illness like infections, diabetes, and cancer. These figures are astonishing. Recently, the medical community has discovered a new way to reduce the risk for coronary heart disease while boosting the body's immune system at the same time. The use of probiotics and prebiotics is one of the newest fields of nutritional research and offers promising benefits to the health of one's heart, immunity, and more.

Probiotics, often referred to as “friendly” or “good” bacteria, are living microorganisms that may be added to foodstuffs which, when consumed in adequate amounts, provide equilibration of the intestinal flora (microorganisms that live in the gastrointestinal tract), thus inhibiting harmful bacteria (e.g., toxin producing bacteria) growth. In general, it is believed that probiotic microorganisms produce organic acids such as lactic acid and acetic acid which inhibit the growth of pathogenic bacteria—bacteria that cause infectious diseases. Probiotic bacteria are therefore believed to be useful in the treatment and prevention of conditions caused by pathogenic bacteria. Further, probiotic microorganisms are believed to inhibit the growth and activity of putrefying bacteria and hence the production of toxic amine compounds. Probiotic bacteria are also believed to activate the immune function of the host. Research has shown that certain probiotics are useful in reducing inflammation, diarrhea, and infections in the digestive tract, lowering cholesterol and blood pressure, preventing colon cancer, and managing lactose intolerance.

Probiotics are available to consumers primarily in the form of dietary supplements, probiotic fortified foods, and fermented dairy products. For example, probiotics may be consumed as part of yogurt, fermented and unfermented milk, miso, tempeh, and some juices and soy beverages.

The most common groups of probiotic bacteria are Lactobacillus (lactic acid bacteria or “LAB”) and Bifidobacterium. Certain yeasts and Bacilli may also be used as probiotics. Within each group, there are different species, such as Lactobacillus acidophilus and Bifidobacterium bifidus, and within each species, there are different strains or varieties, such as Lactobacillus acidophilus NCFM and Bifidobacterium bifidus MF20/5.

The normal human digestive tract contains about 400 types of probiotic bacteria that reduce the growth of harmful bacteria and promote a healthy digestive system. The largest group of probiotic bacteria in the intestine is LAB, of which Lactobacillus acidophilus, found in yogurt, is the best known. Certain yeasts, such as Saccharomyces boulardii, are also considered probiotic substances.

Similar to probiotics, prebiotics are non-digestible substances that stimulate the growth and/or bioactivity of flora (beneficial bacteria) in the digestive system. Typically, prebiotics are carbohydrates (e.g., oligosaccharides and fructooligosaccharides); the most prevalent forms of prebiotics are nutritionally classed as soluble fiber. Dietary sources of prebiotics include soybeans, Jerusalem artichoke, onion, garlic, asparagus, bananas, raw oats, unrefined wheat, unrefined barley and yacon. Some of the oligosaccharides that naturally occur in breast milk are believed to play an important role in the development of a healthy immune system in infants. Other prebiotics include, for example, oligofructose and inulin.

Recently, chewable supplements have been manufactured and sold in the form of a gummy candy supplement. Now a selection of vitamins and other dietary supplements are being manufactured and sold in a chewable gummy form, including both children and adult supplements. The introduction of gummy supplements into the marketplace has been particularly helpful in getting children to take daily vitamin supplements. For adults that do not like swallowing pills, gummy supplements have also provided a non-pill alternative for adults to get their daily vitamin requirements.

Although gummy candy was first introduced in 1920 as “gummy bears,” it was not until very recently that gummy candy was first utilized, by Hero Nutritionals, LLC, San Clemente, Calif., as a delivery system for dietary supplements. Traditional gummy candy is made from a gelatin base, which is similar to the base found in soft caramels, marshmallows, foam-filled wafers, licorice, wine gums, pastilles, chocolate coated mallows and a host of other sweets. Gelatin is a protein derived from animal tissue that forms thick solutions or gels when placed in water. When used in gummy candy, gelatin serves as a binding agent that gives the candy its elasticity and desired chewy consistency.

In addition to gelatin, gummy candies are generally made from a blend of water, sweeteners (e.g., corn starch, corn syrup, and/or sugar), flavors, and colors. When mass produced, a gelatin base or stock is first mixed and pumped into a special candy cooker that cooks the gelatin base with steam. Then, the cooker pumps the gelatin base into a vacuum chamber to remove excess moisture. From the vacuum chamber, the cooked candy moves to a mixing station where colors, flavors, acids, and fruit concentrates are mixed into the cooked candy. Next, a starch molding machine, commonly known as a mogul, pumps the candy stock into starch filled mold boards that shape the candies. After curing, the gummies are removed from the molds and then packaged, delivered, and sold.

Even with the growing popularity of gummy supplements and the increasing use of probiotics and prebiotics as health supplements, to date, gummy candies have not been utilized as delivery systems for probiotics and prebiotics. Thus, a need exists in the art for a safe, easily digestible and palatable delivery system that enables the effective delivery of live microorganisms with or without prebiotics, to the human body to be easily and quickly digested by users of all ages, where the delivery system may be manufactured without compromising the effectiveness of the live microorganisms.

### SUMMARY

An edible, digestible composition is provided that includes a chewable delivery system in the form of a gummy candy, and a predetermined dosage of probiotics and/or prebiotics, originally added in either liquid, frozen concentrate, or freeze-dried form. By ingesting the gummy candy, the consumer is able to directly supply his or her body with active health ingredients.

In some implementations, the gummy candy may include a biding agent, sweetener, flavoring and coloring, and a polishing agent. For example the gummy candy may include gelatin, sucrose, corn syrup, citric acid, lactic acid, natural flavors, fractionated coconut oil, and carnauba wax.

According to another implementation, the delivery system may include a confection selected from the group consisting of: hard candy, fudge, toffee, taffy, liquorice, chocolates, marshmallows and a combination of the foregoing.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following FIGURE. The components in the FIGURE are not necessarily to scale, emphasis instead being placed upon illustrating the principles of the invention.

FIG. 1 is a flow diagram that illustrates one example of a method of manufacturing a chewable supplement with live microorganisms according to the present invention.

### DETAILED DESCRIPTION

The present invention relates to a chewable delivery system designed to enhance the delivery of live microorganisms, namely, probiotics. The chewable delivery system may include prebiotics. The delivery system includes a primary active ingredient (a dosage of probiotics and in some implementations, a dosage of prebiotics) to provide the desired effect (e.g., equilibration of intestinal flora), and a delivery vehicle (e.g., a gummy candy) to contain the active ingredient for delivery.

The primary active ingredient(s) of the present invention may include live microorganisms alone or in combination with other health supplements and/or compounds. For example, in one implementation the active ingredient may include at least one probiotic alone or in combination with a prebiotic. In some implementations, the primary active ingredient may be provided in liquid, frozen concentrate, or freeze-dried form for incorporation in the chewable gummy candy. As for the dosage, probiotics and/or prebiotics of the present invention are generally expressed in terms of grams or milligrams, but may also be expressed in active units, or international units (IU). By way of example only, a single piece of gummy candy may have 200-300 mg of probiotics. In some implementations, the dosages of probiotic and/or prebiotic in each gummy candy should be relatively low, thus allowing the consumer to adjust his/her intake of probiotic and/or prebiotic based on nutritional guidelines applicable to the particular individual.

As used herein, the term “probiotic” is intended to include microorganisms such as bacteria or fungi, either individually or in combination, which exhibit a beneficial effect on human health. Non-limiting examples of probiotics that may be used in conjunction with the present invention include: bifido bacteria (e.g., Bifidobacterium LAFTO B94, Bifidobacterium animalis, Bifidobacterium breve, Bifidobacterium infantis, Bifidobacterium longum and Bifidobacterium bifidum); lactobacilli (“LAB”) (e.g., Lactobacillus acidophilus, Lactobacillus casei, Lactobacillus paracasei, Lactobacillus johnsonii, Lactobacillus plantarum, Lactobacillus reuteri, Lactobacillus rhamnosus, Lactobacillus helveticus, Lactobacillus bulgaricus and Lactobacillus gasseri) saccharomyces (e.g., Saccharomyces boulardii); lactococci (e.g., Lactococcus lactis); streptococci (e.g., Streptococcus thermophiles); propionibacteria; bacilli (e.g., Bacillus coagulans); combinations of the foregoing; and any other microorganism which may be demonstrated to have beneficial effects on the health of the host. The probiotic may be mixed with a prebiotic material (e.g., to form a synbiotic material or compound).

As used herein, the term “prebiotic” refers to a substance such as a protein, peptide, or carbohydrate that, when consumed by a user, allows specific changes in the composition and/or activity in the gastrointestinal microflora so as to confer health benefits and well-being to the user. Non-limiting examples of prebiotics that may be used in conjunction with the present invention include resistant starch, potato starch or high amylose starch such as Starplus, modified starches (including carboxylated starches, acetylated, propionated, and butyrated starches), non-digestible oligosaccharides such as fructooligosaccharides, glucooligosaccharides, xylooligosaccharides, galactooligosaccharides, arabinoxylans, arabinogalactans, galactomannans, polydextrose, oligofructose, inulin, derivatives of these, but not excluding other oligosaccharides able to exert prebiotic effects, other soluble fibers, and combinations of the foregoing. Dietary sources of prebiotics may include, but are not limited to, soybeans, Jersualem artichokes, jicama, chicory root, raw oats, unrefined wheat, yacon, unrefined barley, milk, almonds, honey, garlic, leeks, raw onion, etc.

As used herein, the term “synbiotic” means a combination of one or more probiotics and one or more prebiotics which together have a synergistic beneficial effect on human health.

As used herein, the terms “LMO” or “LMOs” refer to compositions of living microorganisms that include one or more strains of probiotic microorganisms, and which, in some implementations, may initially be provided in liquid, frozen concentrate, or freeze-dried form.

The primary active ingredient, i.e., a probiotic either alone or in conjunction with a prebiotic, is delivered in a delivery vehicle that is palatable and easy to swallow. In one implementation, the delivery vehicle is chewy or gummy-like to facilitate swallowing. The delivery vehicle may include a sweetener(s), a stabilizer(s) or binder(s), a humectant(s), and/or natural and/or artificial flavors. The delivery vehicle may include natural and/or artificial colors and preservatives. In one implementation, the delivery vehicle may include glucose syrup, natural cane juice, gelatin, citric acid, lactic acid, natural colors, natural flavors, fractionated coconut oil, and carnauba wax.

In addition to probiotics and/or prebiotics, the delivery system may include any combination of vitamins, minerals, antioxidants, soluble and insoluble fiber, herbs, plants, fatty acids, amino acids, digestive enzymes, and any other health promoting ingredient. The inclusion of a particular dietary supplement will be dependent in part on its compatibility with the probiotic and/or the prebiotic.

### Manufacturing of Delivery System

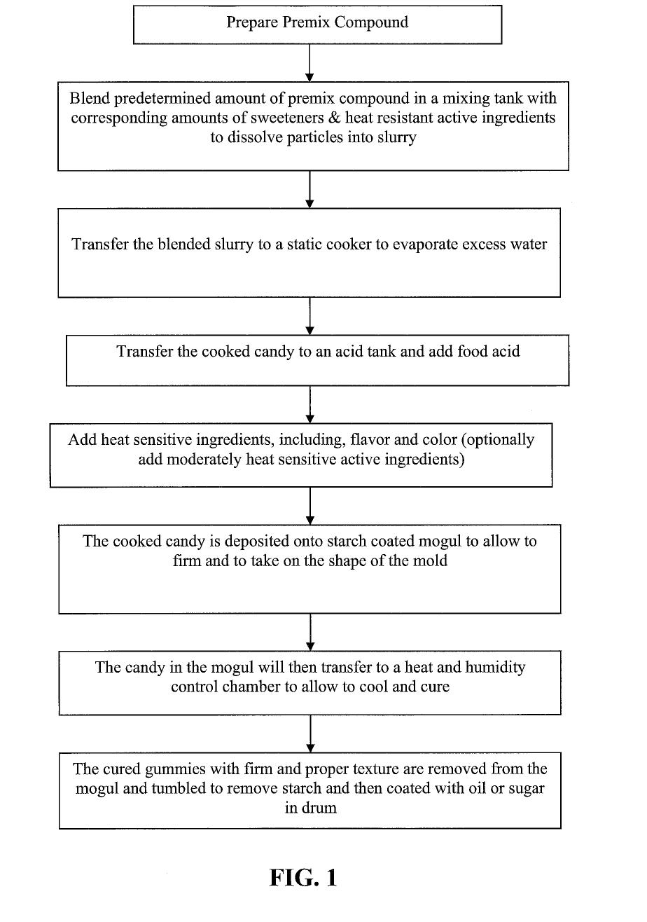

Turning now to FIG. 1, an example of a method 100 for manufacturing a gummy delivery system of the present invention is disclosed. In general, the method of manufacturing involves three main phases: (i) pre-mixing (i.e., compounding) and storing; (ii) batching and cooking; and (iii) depositing and curing.

In the first phase of pre-mixing and storing, the first step 102 includes preparing a premix compound. The premix compound may be prepared by combining water with a binding agent or gelling compound (e.g., gelatin, pectin, starch, carrageenan and/or gum) in a mixing tank, for example. The mixing tank may be any one of a plurality of different sizes. In some implementations the mixing tank may include a 1,000 gallon stainless steel planetary mixer, a scrape surface mixer, a holding tank with an agitator, or any other food-grade mixing apparatus. Although not required, in some implementations, the gelling compound may be mixed with warm water (e.g., water at an initial temperature of about 180° F.) in the mixing tank to facilitate hydration of the gelling compound; i.e., to facilitate efficient mixing of the water and the gelling compound. During production, water and the gelling compound may be continuously mixed. For example, an agitator may be included in the mixing tank to keep the gelling compound from settling on the bottom of the tank. In some implementations, approximately 6,000 lbs to 8,000 lbs of premix compound may be produced in a period of about eight hours. In general, the gelling compound will be mixed with the water until a substantially homogeneous premix compound is formed; i.e., until the premix compound has a substantially uniform composition throughout the mixture.

As stated above, the gelling compound or binding agent may include gelatin, pectin, food starch, carrageenan, gum, or any other suitable binder, or combination thereof. For example, the binding agent may include gelatin products produced from animal sources such as beef or pork, or any other suitable gelatin product. Such products may include GELITA® Gelatine products sold by Gelita USA, Inc.

Examples of gelling compounds including pectin products may include high (methyl)ester or low (methyl)ester pectin products made from fruit sources, such as apples, apricots, carrots, citrus fruits, or any other suitable pectin product. Such products may include, for example, UNIPECTIN® HM-pectin and/or UNIPECTIN® LM-pectin products.

Examples of gelling compounds including starch ingredients may include corn starch, rice starch, potato starch, starch derivatives, and the like.

Examples of gelling compounds including carrageenan ingredients may include kappa (κ) carrageenans sold under the Gelcarin® brand, or lambda (λ) carrageenans sold under the Viscarin® brand, both available from FCM Corporation.

Depending on the binding agent used, the premix compound may include, as a non-limiting example, any one of the following formulations illustrated in Table A:

TABLE A
GELLING COMPOUND FORMULA

| | Binding Agent | Water |
|---|---|---|
| Binding Agent | (% by weight) | (% by weight) |
| gelatin | 50% | 50% |
| pectin | 2%-3% | 97%-98% |
| starch | 7%-10% | 90%-93% |
| pectin/starch | 8%-10% (1%-2% pectin/7%-8% starch) | 90%-92% |
| gelatin/starch | 7%-9% (1%-2% gelatin/6%-7% starch) | 91%-93% |
| carrageenan | 2%-5% | 95%-98% |

In some implementations, a buffer may be added to the mixing tank during preparation of the premix compound in order to regulate the pH of the premix compound. A food grade acid may be used as the buffer, such as citric acid, lactic acid, fumaric acid and/or malic acid. Other buffers include solutions of hydroxides, carbonates, citrates, phosphates, and mixtures thereof and salts thereof, e.g., sodium bisulfate and sodium citrate. As a non-limiting example, the premix compound may include approximately 0.01 to 0.03% by weight of buffer solution, or any other suitable amount for maintaining the pH of the premix compound within a range of from about 3.2 to about 4.0 during mixing.

Once the premix compound is prepared, it may then be filtered through a basket strainer (e.g., a 0.034 inch stainless steel basket strainer) or fine mesh filter material and stored in a holding tank. The holding tank may be various sizes. In one implementation, the holding tank may be a 1,500 gallon stainless steel tank. In some implementations, the holding tank may include a moderate agitator (e.g., mixing blades) for keeping the gelling compound in the premix compound from settling out of the mixture and to the bottom of the holding tank.

In the second phase of batching and cooking, at step 104 of FIG. 1, a predetermined amount of the premix compound may be delivered from the holding tank to a mixing vessel where the premix compound may be mixed and blended with various substances, including sweeteners and the primary active ingredient, i.e., probiotics and/or prebiotics, to form a slurry. The manner in which probiotics and/or prebiotics are incorporated into the gummy delivery system may depend on the heat sensitivity of the particular active ingredient. As will be discussed in greater detail below, LMOs and/or prebiotics that are heat resistant may be added in solid form to the mixing vessel at step 104. As a non-limiting example, 125 lbs to 185 lbs of premix compound may be delivered to the mixing vessel every 5 to 10 minutes during step 104. In some implementations, the mixing vessel in step 104 may be similar or identical in configuration to the mixing tank described above in conjunction with step 102.

In the mixing vessel, water, sweeteners, heat resistant prebiotics and/or probiotics, and additional supplements, if any, may be added to the premix compound to form a slurry mixture, for example. In one implementation, a corn syrup mix along with solid prebiotic may be added to the premix compound in step 104 and may be dissolved in the premix compound to form a slurry mixture. In one implementation, the corn syrup mix may include bulk sugar (that has been filtered and irradiated), water, corn starch, sodium citrate, corn syrup, and white grape puree. In implementations in which the active ingredient is added at step 104, the amount of active ingredient added to the premix may vary depending upon the type of chewable composition (e.g., organic or non-organic) and the desired dosage to be delivered to the consumer in the resulting chewable supplement.

Various sugars may be used as sweeteners for the gummy candy and may be added to the premix compound at step 104. Examples of appropriate sweeteners include, but are not limited to: sucrose (derived from beets or sugar cane, for example); fructose; corn syrup (which may help prevent other sugars from crystallizing in the gummy candy and may help add body to the candy, maintain moisture levels in the candy, and lower the cost of producing the candy); sorbitol, xylitol and maltitol (which are humectants); and/or various combinations of the foregoing. In one implementation, the slurry mixture may contain approximately 70% to 85% sweetener by weight, while the remaining approximately 15% to 30% of the slurry (by weight) may contain the premix compound and additives.

Prior to production, the sweeteners may be stored in bulk tanks. In one implementation, the sweetener may be stored in a holding tank at a temperature of approximately 75° F. For example, in a sweetener holding tank including corn syrup, the syrup may be irradiated by ultraviolet light to remove any contaminants in the syrup. The syrup may include high fructose corn syrup (e.g., HFCS-42, HFCS-55, or HFCS-62), glucose syrup, rice syrup, tapioca syrup, or any other suitable liquid sweetener or combination thereof. During production, the syrup may be administered to the mixing vessel manually or by automation.

Similarly, prior to production, sugar in granular form may be stored in a holding tank. During production, sugar may be fed through an automated feed system that filters the sugar to remove sediments, weighs the sugar, and delivers a desired quantity of sugar to the mixing vessel. In other implementations, sugar may be added to the mixing vessel manually.

In some implementations, various dietary supplements may by added to the premix compound at step 104, such as vitamins, minerals, herbs, plants, amino acids, enzymes or any other supplements digested to promote the health and well-being of a person. Such supplements may include, but not be limited to, any of the following:

Vitamin B1 (Thiamine)

Vitamin B2 (Riboflavin)

Vitamin B3 (Niacinamide)

Vitamin B5 (Pantothenic Acid)

Vitamin B6 (Pyridoxine HCL)

Vitamin B12

Biotin

Folic Acid

Vitamin C (Ascorbic Acid/Activated C)

Calcium

Carotine

Chromium

Copper

Vitamin D (Cholecalciferol)

Vitamin E

Ginseng

Iron

Vitamin K (Phytonadione)

St. John's Wort

The above list of dietary supplements is not exhaustive, but is provided for illustrative purposes only. The length of a list of all available dietary supplements that may be utilized in the chewable composition of the invention is too lengthy to provide.

Once the premix compound is blended with the predetermined amounts of sweetener (and in some implementations, heat-resistant prebiotic(s) and/or prebiotic(s)), the resulting slurry may be heated to evaporate excess water, as shown in step 106 of FIG. 1. In some implementations, step 106 may include a series of substeps. In one implementation, at step 106, the slurry from the mixing vessel may be processed through a magnetic device, such as a finger magnet or any other suitable magnetic device, which removes particulates in the slurry. As the slurry is processed through the magnetic device, the slurry may pass through a series of heat exchangers in order to heat the slurry to a predetermined temperature; e.g., 150° F. to 185° F. Since step 106 may include heating the slurry to relatively high temperatures, only active ingredients with a high resistance to heat (e.g., prebiotics and/or probiotics that may withstand temperatures in excess of 200° F. without breakdown of the molecular structure of the prebiotics and/or probiotics) should be added at step 104 (e.g., in solid form). As the slurry passes through the series of heat exchangers, the slurry may be received by a storage buffer tank, such as a 5,000 gallon stainless steel industrial holding tank, for example. In some implementations, the storage buffer tank may include a moderate agitator to keep any active ingredients from settling to the bottom of the storage buffer tank, for example. From the storage buffer tank, the warm slurry may flow to a static cooker where excess water may be evaporated from the slurry. In some implementations, evaporated water may be condensed, filtered and recycled for processing at step 102, for example. In the static cooker, in some implementations, the slurry may be cooked to a temperature of approximately 220° F. to 260° F. for approximately 30 sec. to 60 sec., until the slurry is gelatinized (i.e., dehydrated). In one implementation, the static cooker may be a 2,500 gallon high pressure steam jacketed kettle, a vacuum pressure cooker, or any other suitable cooker. In the static cooker, moisture is evaporated out of the candy slurry as the slurry is boiled. After about a minute of boiling, the slurry may consist of about a 65 to 75 brix solution.

As used herein, the term “brix” refers to the dissolved sugar-to-water ratio of a liquid or gel. For example, as described above, after boiling, in some implementations, the slurry mixture may include a ratio of dissolved sugar-to water of about 65:35 to about 75:25, on a weight/weight basis.

After the candy slurry is cooked, the cooked candy may be subjected to a vacuum. In one implementation, the static cooker may include a vacuum apparatus. In another implementation, the cooked candy may be delivered to an industrial vacuum chamber or any other suitable enclosure including a vacuum apparatus. In the vacuum, moisture is drawn from the cooked candy by suction pressure. In some implementations, a vacuum of approximately 40 psi to 50 psi may be applied to the candy stock for approximately 15 sec. to 30 sec. However, the pressure of the vacuum and the vacuum rate will vary according to the capabilities and size of the vacuum apparatus. At this juncture, in some implementations, the cooked candy may have a brix of approximately 67 to 80, and a pH of approximately 2.8 to 4.0, for example. The cooked candy may then be filtered through a strainer.

Once cooked and filtered, as shown in step 108, the cooked candy may be transferred to a food acid tank and mixed with food acid to help control the pH of the cooked candy. Examples of food acids include: citric acid, lactic acid, fumaric acid, malic acid, ascorbic acid and the like. After adding the food acid(s), at step 110 moderately heat sensitive ingredients may be added to the cooked candy, such as various flavorings and color additives, as well as moderately heat sensitive probiotics and/or prebiotics. For example, LMOs and/or prebiotics may be added to the cooked candy in solid form at step 108 or 110. To help protect moderately heat sensitive probiotics and/or prebiotics, the probiotics and/or prebiotics may be encapsulated. Encapsulated prebiotics and/or probiotics may be added at step 104 in some implementations. In some implementations, encapsulated prebiotics and/or probiotics may be added before or during steps 108 or 110. Encapsulation involves formulating a soft gel cap to cover the active ingredient, where the soft gel cap has heat resistant properties. In some implementations, the soft gel cap is a one-piece, hermetically sealed soft gelatin shell containing a liquid or semisolid called a fill. The soft gel shell may include a film-forming material such as gelatin, and a water-dispersible or water-soluble plasticizer (to impart flexibility). The soft gel shell may also include minor additives such as coloring agents, flavors, sweeteners and preservatives.

In some implementations, steps 108 and 110 may be performed simultaneously, or step 110 may be performed prior to step 108. For example, in some implementations, the cooked candy may be passed through a trough-like apparatus known as a dosier. In the dosier, water, flavoring, coloring, and food grade acid may be added to the cooked candy to enhance the candy's taste and appearance. For example, flavoring such as artificial flavoring (i.e., mixtures of aromatic chemicals, including, but not limited to methyl anthranilate and ethyl caproate) and/or natural flavoring (i.e., flavoring obtained from fruits, berries, honey, molasses, maple sugar and the like) may be added to the cooked candy to give the candy a desired flavor. To balance the flavor (in addition to regulating the pH of the cooked candy), food grade acid may be added to the cooked candy. Such food acids may include citric acid, malic acid, lactic acid, adipic acid, fumaric acid, tartaric acid, or any other suitable food grade acid, or combination thereof. In one implementation, the flavoring, coloring, and acid may be continuously added to (e.g., dripped on) the cooked candy as the candy moves through the dosier to a starch depositor. Color additives in various combinations may be added to the cooked candy to achieve the desired color, including: red dye #40; yellow dye #5; yellow dye #6; blue dye #1, and combinations thereof. Color additives may also include natural coloring such as black carrot, annatto, tumeric, and purple berry concentrate.

The amount of flavoring, coloring, and acid added to the cooked candy at steps 108 and 110 may vary according to the volume of cooked candy passing through the dosier, for example, and the desired candy formulation. As but one example, approximately 1% to 2% flavoring by weight and approximately 0.01% to 0.03% acid by weight may be added to the cooked candy composition. However, the amount of acid and flavoring added to the cooked candy formulation must be balanced to ensure the desired taste. Thus, depending on the formulation, more flavoring and less acid may be added to the cooked candy for bitter formulations, for example. For instance, to mask the flavor of a particular active ingredient in the cooked candy, a flavoring agent such as strawberry flavor or cherry flavor may be added to the mixture. The additional flavor may be adjusted based upon the active ingredient's dosage. In some instances, only food acid may be added to the cooked candy.

In some implementations, titanium dioxide may be added to the cooked candy at either step 108 or 110 to provide sheen. Those of skill in the art will recognize that various shine-enhancing agents may be utilized in conjunction with the present invention. Titanium dioxide may also stabilize the cooked candy formulation so the coloring does not bleed when it is handled, packaged, or stored.

Prior to the depositing and curing phase, the cooked candy may be subjected to quality control; i.e., the cooked candy may be checked for proper brix, pH, temperature, and proper organoleptic effects, among other characteristics.

After steps 108 and 110, the candy is ready for the depositing and curing phase, and may be transferred to a starch depositor or molding machine at step 112. In one implementation, the starch molding machine may include any commercially available starch depositing equipment (simply referred to as a “Mogul”). Thus, as shown at step 112, the cooked candy may be deposited onto a starch-coated mold to allow the cooked candy to become firm and to take on the shape of the mold. A Mogul is a starch molding machine that automatically performs the multiple tasks involved in making gummy candy. Gummy candy may be produced in the Mogul batch-wise or via a continuous process. To start the process, the cooked candy, or gummy stock, is deposited by depositors (e.g., filling nozzles) onto starch lined trays (“mogul boards”). The mogul boards allow the cooked candy to firm and take on the shape of the tray mold, to produce a series of shaped gummy candies. In one implementation, the depositors are timed to automatically deliver the exact amount of candy needed to fill the trays as the mogul boards are passed under the depositors. In some implementations, the coloring, flavoring, and acids added to the cooked gummy candy at steps 108 and 110 may be added to the candy in the depositor.

A Mogul is called a starch depositor because starch is a main component of the machine. In this machine, starch has three primary purposes. First, it prevents the gummy candy stock from sticking to the mogul boards, which allows for easy removal and handling. Second, starch holds the gummy candy in place during the drying, cooling, and setting processes. Finally, starch absorbs moisture from the candies, giving them the proper texture.

In some cases, the starch used to coat the mogul boards may include recycled starch; i.e., wet starch that falls away from the candies when they are removed from the mogul boards. The re-used starch may be recycled to a starch dryer where the starch is sifted and dried. After the starch is dried, it may then be cooled in a starch cooler. The cooled starch may be sifted a second time and returned to the Mogul where it may be re-circulated once again, through the same process. The recycled starch may then be sprayed evenly on the mogul board, where the cooked candy may then be deposited onto mogul boards coated with the recycled starch.

After the cooked candy is deposited onto the mogul boards, the mogul boards may be stacked, then removed from the stack (one-by-one) by a conveyor belt, and finally placed in a temperature and humidity controlled curing room, where the candy sits and cools (i.e., is cured), for approximately 24 hours to 48 hours in some implementations (step 114). However, the curing time for the cooked candy may vary based on the particular binding agent used in the candy and the temperature and humidity of the curing room. Proper curing time is necessary to solidify, or set the gummy product to ensure ease of packaging without breakage and proper yield. In some implementations, the candy may be cured in a curing room with approximately 15% to 25% humidity.

After curing, the gummy candies, firmed and having proper texture, may be moved to a section of the Mogul called the starch buck. In the starch buck, the mogul boards are inverted and the gummy candies are dumped into a tumbler machine at step 116. In one implementation, the tumbler may include a 2,000 gallon rotating drum or, in other implementations, a vibrating metal sieve. In the tumbler, the gummies may be tumbled together to remove any excess starch that adheres to the gummy candies. In some implementations, the vibrating metal sieve may include oscillating brushes for removing excess starch adhered to the gummies. In some implementations, excess starch may be removed by fast-rotating compressed air jets. Once the starch is removed, the gummies may become sticky, so the gummies may be coated with a polishing compound or lubricating agent to prevent the cooked candies from sticking together. Depending on the desired finished product or preferences, the gummies may be polished with fractionated coconut oil, linseed oil, sunflower oil, bees wax, carnauba wax, mineral oil, partially hydrogenated soybean oil, pear concentrate, confectioner's glaze or any other suitable food grade oil or combination thereof. In other implementations, the gummies may be sanded with sugar or a sugar substitute in a drum.

In implementations in which the active ingredient (e.g., probiotic(s) and/or prebiotic(s)) are particularly sensitive to heat, the active ingredient may be incorporated into the gummy delivery system in liquid form (e.g., extract) or frozen form (e.g., frozen yogurt) in a multiple-deposit step prior to curing (step 114), or after curing during coating step (step 116). In the multiple-deposit step, the gummy stock may be deposited on the mogul boards during a first deposit step. Next, the heat sensitive active ingredient(s) may be added to a syrup (e.g., a sugar and water syrup) that is deposited on the gummy stock during a second deposit step. The gummy stock is then allowed to cure, thus having an active ingredient-containing syrup coating. In alternative implementations, heat sensitive active ingredients may be added to solid sugar particles, thus creating a sugar coating that may be applied to the gummy candy during the step 116 of the manufacturing process 100.

After the gummies are coated, they may be placed on an inspection belt where the candies are inspected for food safety and proper organoleptic effects. For example, on the inspection belt the gummy candies may be passed by a detector or x-ray to insure that no particulate or other foreign material has been deposited into the candy during the depositing stage. Once the candy passes inspection, it is packaged for distribution.

During packaging and storage, the finished gummy candies may be refrigerated to maintain the shelf-life and efficacy of the LMOs, for example. Alternatively, the gummy candies may be specially packaged, for example, in a vacuum pack injected with liquid nitrogen

The disclosure above only describes one implementation of a method of manufacturing a delivery system of the present invention. Other methods and implementations may be used to manufacture delivery systems in accordance with the present invention. For example, the various steps described in FIG. 1 may be carried out in any suitable order, there being no explicit limitations on the order of the steps set forth above.

### EXAMPLES

The following examples describe particular formulations and concentrations thereof for preparing chewable supplements containing LMOs and/or prebiotics of the present invention. Chewable supplements of the present invention may include non-organic and/or organic compositions. As used herein, the term “organic” refers to foods wherein at least 95% of its ingredients are produced using methods that do not involve modern synthetic inputs such as synthetic pesticides and chemical fertilizers, do not contain genetically modified organisms, are not processed using irradiation, industrial solvents, or chemical food additives, or as otherwise defined in the Organic Foods Production Act (OFPA) of 1990 and regulations in Title 7, Part 205 of the Code of Federal Regulations. For example, in some implementations, the chewable supplement may include a non-organic or an organic gummy candy. While the overall process of manufacturing a non-organic gummy and an organic gummy may involve the same steps as described above, the particular formulations of organic and non-organic delivery systems will differ. For non-organic formulations, at step 110, water may be mixed with any binding agent in the mixing tank. For example, the binding agent may include pectin, gelatin, starch, gum, or any combination thereof. In another implementation, the delivery system of the present invention may include an organic gummy. To create an organic gummy, the ingredients used to form the drug must meet the requirements for organic certification. As used herein, the terms “organic compliant” or “organic certification” refer to products containing (by weight or fluid volume, excluding water and salt) not less than 70% organically produced raw or processed agricultural products. These ingredients may include, but not be limited to, organic evaporated cane juice, organic tapioca syrup, organic grape juice, citric acid, lactic acid, sodium citrate, natural color (e.g., black carrot juice concentrate, annatto, turmeric, purple berry concentrate) and natural flavor (e.g., strawberry, orange, pineapple, grape), LMOs and prebiotics.

### A. Probiotic Formulation

In some implementations, the delivery system of the present invention may include one or more probiotics. For example, a chewable supplement with a probiotic in accordance with the present invention may include the following composition:

TABLE B
PROBIOTIC GUMMY FORMULA

| Ingredients | Content (by Weight) |
|---|---|
| Lactic acid | 1.0% |
| Citric acid | 1.0% |
| Sugar (organic or inorganic) | 35.0% |
| Syrup/sweeteners (organic or inorganic) | 50.0% |
| Gelatin/Pectin/Starch Mix | 7.0% |
| Yakult ™ (Lactobacillus casei)* | 4.0% |
| Flavoring | 1.5% |
| Coloring | 0.5% |

*An average piece of gummy candy having a weight of, for example, about 2.4 grams, may contain a probiotic concentration of approximately 10 million Lactobacillus casei shirota, which is the equivalent of 0.1 mL of Yakult ™.

In this example, about 93 lbs of warm water may be mixed with about 7 lbs of gelatin/pectin/starch compound (“binding agent”) in the mixing tank to form 100 lbs of premix compound having a homogeneous 93/7 blend of water and binding agent.

In the mixing vessel, the premix compound may be mixed with about 6 lbs of water, 35 lbs of natural cane juice (i.e., the sugar), and 50 lbs of glucose syrup to form the slurry.

Next, the candy slurry may be heated to a temperature of about 180° F. prior to being passed through the storage buffer tank, to the static cooker. In the static cooker, the candy slurry may be heated to a temperature of about 240° F. to 245° F., dehydrating the slurry.

After the candy is cooked, the cooked candy may be sent to the vacuum, where the candy may be further dehydrated. After leaving the vacuum, the cooked candy may be placed in the dosier where about 1.5% of cranberry and orange flavoring by weight and about 0.5% of black carrot juice coloring by weight may be added to the cooked candy. To balance the flavoring, citric acid and lactic acid may be added to the cooked candy.

After adding the flavoring and coloring, the cooked candy may be deposited into the Mogul machine where liquid Yakult™ (which includes the probiotic Lactobacillus casei) may be deposited on the candy before being cured. After the candies are cured, they may be added to a tumbling drum to break off any starch that may be remaining on the candies. As the candies are being tumbled, about 1% fractionated coconut oil by weight and about 1% carnauba wax by weight may be poured into the drum to coat the candies to prevent them from sticking together.

After the candies are coated, they may be inspected to validate that the finished product meets the label requirements, and then packaged.

### B. Synbiotic Formulation

In some implementations, the delivery system of the present invention may include one or more probiotics and one or more prebiotics (i.e., a synbiotic chewable composition). For example, a chewable supplement with a probiotic and a prebiotic in accordance with the present invention may include the following composition:

TABLE C
SYNBIOTIC GUMMY FORMULA

| Ingredients | Content (by Weight) |
|---|---|
| Lactic acid | 1.0% |
| Citric acid | 1.0% |
| Sugar (organic or inorganic) | 34.0% |
| Syrup/sweeteners (organic or inorganic) | 50.0% |
| Gelatin/Pectin/Starch Mix | 7.0% |
| Dannon Activia ™ (Bifidus regularis)* | 2.0% |
| Banana (prebiotic source) | 1.0% |
| Other dietary supplements | 2.0% |
| Flavor | 1.5% |
| Color | 0.5% |

*An average piece of gummy candy having weight of, for example, about 2.4 grams, may contain a probiotic concentration of approximately 4.2 million Bifidus Regularis, which is the equivalent of 47.6 mg of Dannon Activia ®.

In this example, about 93 lbs of warm water may be mixed with about 7 lbs of gelatin/pectin/starch compound (“binding agent”) in the mixing tank to form 100 lbs of premix compound having a homogeneous 93/7 blend of water and binding agent.

In the mixing vessel, the premix compound may be mixed with about 6 lbs of water, 34 lbs of natural cane juice (i.e., the sugar), and 50 lbs of glucose syrup to form the slurry.

Next, the candy slurry may be heated to a temperature of about 180° F. prior to being passed through the storage buffer tank, to the static cooker. In the static cooker, the candy slurry may be heated to a temperature of about 240° F. to 245° F., dehydrating the slurry.

After the candy is cooked, the cooked candy may be sent to the vacuum, where the candy may be further dehydrated. After leaving the vacuum, the cooked candy may be placed in the dosier where about 1.5% of cranberry and orange flavoring by weight and about 0.5% of black carrot juice coloring by weight may be added to the cooked candy. To balance the flavoring, citric acid and lactic acid may be added to the cooked candy.

After adding the flavoring and coloring, the cooked candy may be deposited into the Mogul machine where Dannon Activia™ yogurt (which includes the probiotic Bifidus regularis) may be deposited on the candy before being cured. The yogurt may be premixed with a syrup for coating the candies. In addition, banana extract or banana concentrate may be deposited on the candy as a prebiotic source. In some implementations, banana may be added at step 104, as described above. Raw banana contains approximately 1% prebiotic fiber content by weight. After the candies are cured, they may be added to a tumbling drum to break off any starch that may be remaining on the candies. As the candies are being tumbled, about 1% fractionated coconut oil by weight and about 1% carnauba wax by weight may be poured into the drum to coat the candies to prevent them from sticking together.

After the candies are coated, they may be inspected to validate that the finished product meets the label requirements, and then packaged.

The examples provided above are for illustrative purposes only. Formulations for chewable supplements of the present invention may vary based on the desired dosage of LMOs and/or prebiotics, or the amount of other dietary supplements, additives, sweeteners, and coloring added to the composition.

While implementations of the invention have been described with reference to a gummy delivery system, the invention is not limited to this application and may be readily used for any chewable or digestible composition. For example, implementations of the invention may also be employed in organic, vegetarian or non-vegetarian tablets, capsules, or solid candies. For purposes of the present invention, the term “vegetarian” refers to a product or composition that does not contain any animal ingredients or by-products. The present invention may also apply to other forms of candies such as jelly beans or caramel-based candies. Further, while the dimensions of the holding and mixing vessels are provided herein by way of example only, the actual dimensions of these vessels may vary based on the amount of premix compound and candy slurry produced in a given time period (e.g., per day).

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A chewable composition comprising:
a binding agent;
a sweetener; and
a compound including a live microorganism.

2. The chewable composition of claim 1, wherein the compound includes at least one probiotic.

3. The chewable composition of claim 1, wherein the compound includes at least one prebiotic.

4. The chewable composition of claim 1, wherein the compound is synbiotic.

5. The chewable composition of claim 1, wherein the binding agent includes a component selected from the group consisting of: gelatin, pectin, starch, carrageenan, gum and combinations thereof.

6. A chewable composition comprising:
an organic binding agent;
an organic sweetener; and
a compound including live microorganisms.

7. The chewable composition of claim 6, wherein the compound includes at least one probiotic that is organic-compliant.

8. The chewable composition of claim 6, wherein the compound includes at least one prebiotic derived from an organic source.

9. The chewable composition of claim 6, wherein the compound is synbiotic.

10. The chewable composition of claim 6, wherein the binding agent includes a component selected from the group consisting of: gelatin, pectin, starch, carrageenan, gum and combinations thereof.

11. The chewable composition of claim 6, further comprising a dietary supplement selected from the group consisting of: vitamins, minerals, nutraceuticals, herbs, fibers, antioxidants, amino acids, digestive enzymes, fatty acids, dietary supplements, and combinations thereof.

12. A method of forming a chewable supplement including live microorganisms, comprising:
preparing a premix compound;
blending a portion of the premix compound with a sweetener and a compound including live microorganisms to form a blended slurry;
cooking the blended slurry to form a cooked candy;
adding food acid, flavor and color to the blended slurry; and
curing the cooked candy to form a chewable supplement including live microorganisms.

13. The method of claim 12 wherein the chewable supplement includes about 200 to about 300 mg of at least one probiotic.

14. The method of claim 12, further comprising adding a prebiotic-containing compound to the premix compound.

15. The method of claim 12, wherein the compound including live microorganisms is added to the premix compound in solid form.

16. A method of forming a chewable supplement including live microorganisms, comprising:
preparing a premix compound;
blending a portion of the premix compound with a sweetener to form a blended slurry;
cooking the blended slurry to form a cooked candy;
adding food acid, flavor and color to the blended slurry;
adding a compound including live microorganisms to the cooked candy;
curing the cooked candy to form a chewable supplement including live microorganisms.

17. The method of claim 16 wherein the chewable supplement includes about 200 to about 300 mg of at least one probiotic.

18. The method of claim 16, further comprising adding a prebiotic-containing compound to the cooked candy.

19. The method of claim 16, wherein the compound including live microorganisms is mixed with a syrup before being added to the cooked candy.

20. The method of claim 19, wherein adding the compound including live microorganisms to the cooked candy comprises coating the cooked candy while the cooked candy is curing.
